(19) United States
(12) Patent Application Publication
(10) Pub. No.: US 2015/0076970 A1
(43) Pub. Date: Mar. 19, 2015

(54) ROTARY ELECTRIC MACHINE

(71) Applicant: DENSO CORPORATION, Kariya-city (JP)

(72) Inventor: Shinya OOWATARI, Anjo-shi (JP)

(21) Appl. No.: 14/490,319

(22) Filed: Sep. 18, 2014

(30) Foreign Application Priority Data
Sep. 19, 2013 (JP) 2013-194712

(51) Int. Cl. H02K 9/06; H02K 11/00; H02K 9/02

(52) U.S. Cl. CPC H02K 9/06; H02K 9/02; H02K 11/0073
USPC 310/60 R

(57) ABSTRACT

A rotary electric machine is provided which includes a rotor, a stator, a power circuit which includes a power element, a control circuit which controls the power element, a frame which accommodates the rotor and the stator, a cooling fin which is made of metal and is connected to the frame to cool the power circuit, and a fixing member which is made of metal and is connected to the cooling fin to fix the control circuit.

### CROSS-REFERENCE TO RELATED APPLICATION

This application is based on and claims the benefit of priority from earlier Japanese Patent Application No. 2013-194712 filed Sep. 19, 2013, the description of which is incorporated herein by reference.

### BACKGROUND

1. Technical Field

The present invention relates to a rotary electric machine mounted such as to passenger cars and trucks.

2. Related Art

For downsizing a rotary electric machine as well as a control circuit thereof, there has been proposed a structure in which the rotary electric machine and the control circuit are integrally provided. For example, in a known rotary electric machine, a control board including a control circuit is connected to a bracket of the rotary electric machine via a metal fixing member having a high rigidity (e.g., see a patent publication JP-B-4402091).

In the structure disclosed in the patent literature JP-B-4402091, both of the control board and the bracket are connected to the metal fixing member having a high rigidity. Therefore, the heat generated in the rotary electric machine is transferred to the control board via a housing which is formed, in general, of a material having high heat conductivity (e.g., aluminum) and via a metal fixing member, thereby creating a problem of worsening the cooling performance for the control circuit.

### SUMMARY

An embodiment provides a rotary electric machine which can suppress transfer of heat to a control circuit to enhance the cooling performance.

As an aspect of the embodiment, a rotary electric machine is provided which includes: a rotor; a stator; a power circuit which includes a power element; a control circuit which controls the power element; a frame which accommodates the rotor and the stator; a cooling fin which is made of metal and is connected to the frame to cool the power circuit; and a fixing member which is made of metal and is connected to the cooling fin to fix the control circuit.

### BRIEF DESCRIPTION OF THE DRAWINGS

In the accompanying drawings:

FIG. 1 is a diagram illustrating a general configuration of a motor-generator for vehicle, according to an embodiment;

FIG. 2 is a connecting diagram, including a power converter, of the motor-generator for vehicle according to the embodiment; and

FIG. 3 is a diagram illustrating a modification of a cooling fin and a peripheral structure of a fixing member.

### DETAILED DESCRIPTION OF THE PREFERRED EMBODIMENTS

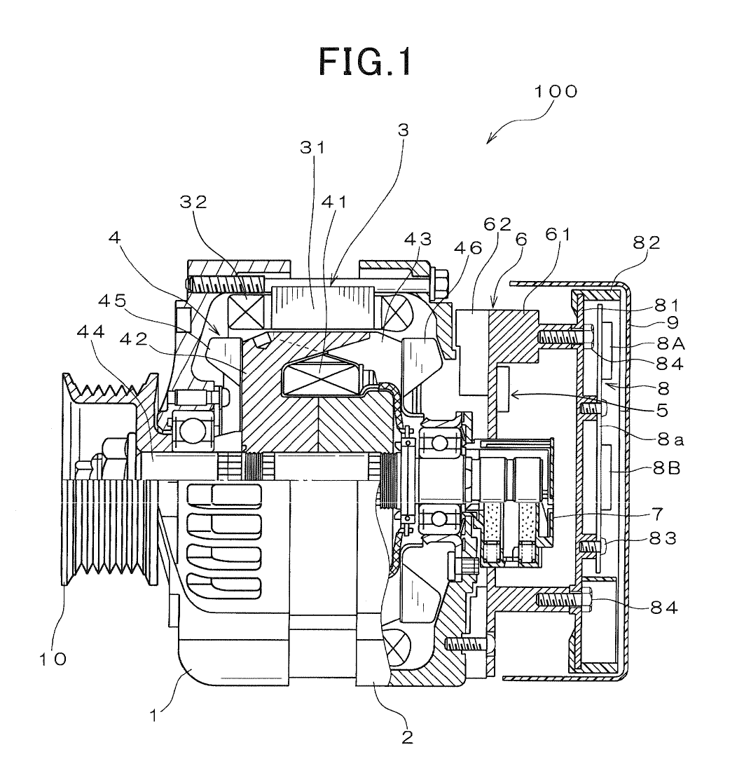

With reference to the accompanying drawings, hereinafter is described in detail an embodiment of a motor-generator for vehicle according to an embodiment to which a rotary electric machine of the present invention is applied. FIG. 1 is a diagram illustrating a general configuration of a motor-generator 100 for vehicle, according to the embodiment. As shown in FIG. 1, the motor-generator 100 includes a front frame 1, a rear frame 2, a stator 3, a rotor 4, a power converter 5, a cooling fin 6, a brush unit 7, a control circuit 8, a rear cover 9 and a pulley 10.

The front frame 1 and the rear frame 2 accommodate and support the rotor 4 and the stator 3. The front and rear frames 1 and 2 are both in a bowl shape and fixed to each other via a plurality of bolts, in a state where the openings of the frames are opposed to each other to sandwich the stator 3 therebetween. The front frame 1 and the rear frame 2 are formed by means of aluminum die casting or the like. The stator 3 includes a stator core 31 and a stator winding 32. The stator core 31 is arranged so as to face the rotor 4. The stator winding 32 is applied to the stator core 31.

The rotor 4 includes a field winding 41 and a rotary shaft 44. The field winding 41 magnetizes pole cores 42 and 43 serving as field poles. The rotor 4 is rotatably held by a pair of bearings, which are housed in respective bearing boxes provided to the front frame 1 and the rear frame 2. The pole cores 42 and 43 have respective axial end faces to which a front cooling fan 45 and a rear cooling fan 46, respectively, are mounted. The rotary shaft 44 has a front end to which the pulley 10 is connected via a nut. The rotary shaft 44 has a rear end which is located outside the rear frame 2 and provided with a pair of slip rings that are connected to the respective ends of the field winding 41. Excitation current is supplied to the field winding 41 via the slip rings and the brush device 7.

The power converter 5 is a power circuit that includes power elements. The power converter 5 is connected to the stator winding 32 to carry out at least one of the performances of converting alternating-current electromotive force induced in the stator winding 32 to direct current and converting direct-current power stored in a battery (not shown) to alternating current to supply the alternating current to the stator winding 32.

The cooling fin 6 is made of metal and is connected to the rear frame 2 to cool the power converter 5. The cooling fin 6 includes a flat portion 61 and a projected portion 62. The flat portion 61 is provided to a first surface of the cooling fin 6, the first surface being opposite to the rear frame 2, to mount the power converter 5 thereon. The projected portion 62 is provided to a second surface (on the rear frame 2 side) of the cooling fin 6, the second surface being opposite to the flat portion 61. The flat portion 61 and the projected portion 62 are integrated to each other to thereby form the cooling fin 6. For example, the cooling fin 6 is formed by aluminum die casting. The rear cooling fan 46 that rotates with the rotor 4 takes cooling air into the rear frame 2 to cool the cooling fin 6.

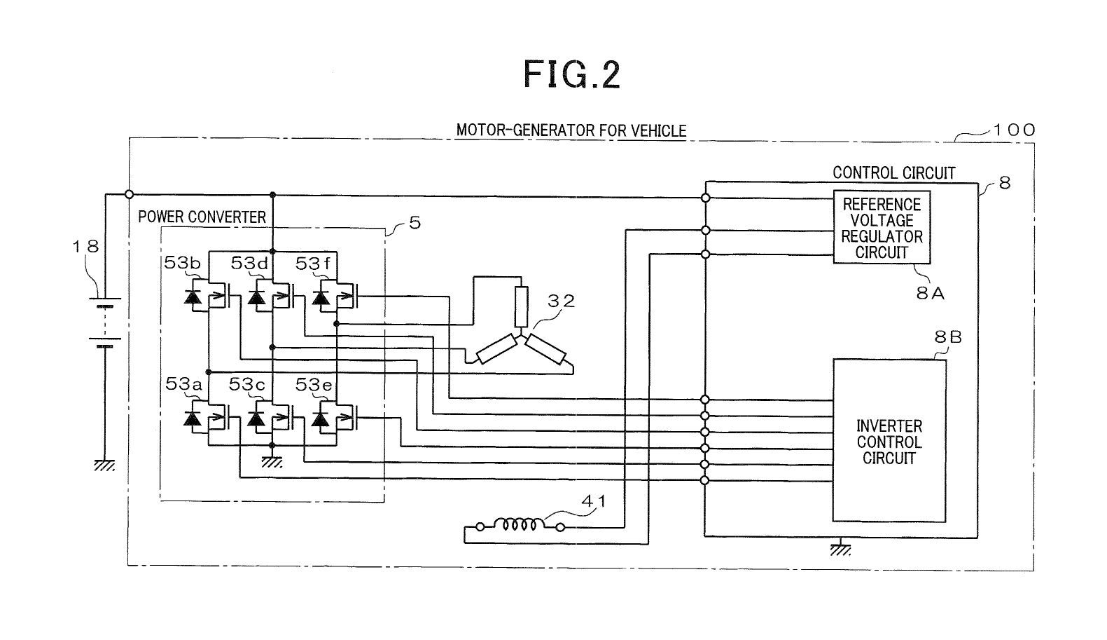

As shown in FIG. 2, the power converter 5 is configured by a plurality of power elements, i.e. a plurality of (e.g., three) low-side switching elements 53a, 53c and 53e and a plurality of (e.g., three) high-side switching elements 53b, 53d and 53f.

The three low-side switching elements 53a, 53c and 53e and the three high-side switching elements 53b, 53d and 53f are each configured such as by an N-channel MOS-FET. These switching elements are arranged on the first surface of the cooling fin 6 directly or via a circuit board.

As shown in FIG. 2, the power converter 5 is a three-phase bridge circuit configured by the three low-side switching elements 53a, 53c and 53e and the three high-side switching elements 53b, 53d and 53f and is connected to the stator winding 32 that is a three-phase winding of the stator 3.

In a generator operation, the bridge circuit functions as a three-phase full-wave rectifier that performs a rectification operation which is a synchronous rectification for converting the alternating-current voltage induced in the stator winding 32 to direct current. In a motor operation, the bridge circuit functions as an inverter circuit that performs on/off control under which the six switching elements are turned on/off at a predetermined timing for each phase of the stator winding 32 to convert a direct-current voltage applied by a battery 18 to a three-phase alternating-current voltage.

The control circuit 8, which controls the motor-generator 100 to have it perform either the generator operation or the motor operation, is configured by a reference voltage regulator circuit 8A and an inverter control circuit 8B. When the motor-generator 100 performs the generator operation, the reference voltage regulator circuit 8A regulates the field current supplied to the field winding 41 of the rotor 4 to thereby control the output voltage of the motor-generator 100 so as to be a reference voltage (regulated voltage).

When the motor-generator 100 performs the generator operation, the inverter control circuit 8B carries out on/off control under which the six switching elements 53a to 53f included in the power converter 5 are turned on/off to generate a synchronous rectification control signal or the like for allowing the power converter 5 to perform the synchronous rectification. Further, when the motor-generator 100 performs the motor operation, the inverter control circuit 8B carries out on/off control under which the six switching elements 53a to 53f included in the power converter 5 are turned on/off to generate a control signal (gate input signal) for allowing the power converter 5 to generate three-phase alternating current.

In the present embodiment, the control circuit 8 is housed in a resin case 82 provided with a metal (e.g., aluminum) fixing member 81 that is formed by insert molding. The control circuit 8 is connected to the fixing member 81 via screws 83 made of metal. In the example shown in FIG. 1, the control circuit 8 includes a control board 8a which is connected to the fixing member 81 via the screws 83. The fixing member 81 is connected to the cooling fin 6 via bolts 84, serving as connecting members, made of metal.

In the motor-generator 100 of the present embodiment, the fixing member 81 for fixing the control circuit 8 to the rear frame 2 is connected to the rear frame 2 via the cooling fin 6. Accordingly, heat transfer from the rear frame 2 to the control circuit 8 is suppressed and thus the cooling performance for the control circuit 8 is enhanced. Further, the control circuit 8 is fixed to the rear frame 2 via the fixing member 81 and the cooling fin 6 each made of metal. Accordingly, the vibration that is transmitted from the rear frame 2 to the control circuit 8 during the operation of the motor-generator 100 is more suppressed from being amplified compared with the case where a member formed of a resin material is interposed therebetween.

In particular, the cooling fin 6 is cooled by the cooling air that is taken into the rear frame 2 by the rear cooling fan 46 that rotates with the rotor 4. Accordingly, the temperature of the cooling fin 6 is reliably lowered to reduce the heat received by the control circuit 8.

By ingeniously developing the quality or the like of the fixing member 81 and the bolts 84, the cooling performance of the control circuit 8 can be further improved.

(Modification 1)

The bolts 84, serving as connecting members, are formed of a material (metallic material) having heat conductivity lower than that of the cooling fin 6. For example, the fixing member 81 and the cooling fin 6 are formed of aluminum, while the bolts 84 are formed of stainless steel having heat conductivity lower than that of aluminum. Thus, heat is prevented from being transferred to the fixing member 81 from the cooling fin 6 via the bolts 84.

(Modification 2)

The fixing member 81 is formed of a metallic material having heat conductivity lower than that of the cooling fin 6. For example, the cooling fin 6 is formed of aluminum, while the fixing member 81 is formed of stainless steel. In this case, the bolts 84 may also be formed of stainless steel, serving as a metallic material, having heat conductivity lower than that of the cooling fin 6. Thus, heat is prevented from being transferred from the cooling fin 6 to the control circuit 8 via the fixing member 81.

(Modification 3)

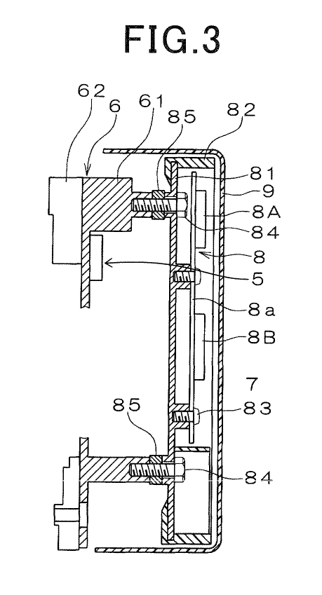

As shown in FIG. 3, cylindrical members 85, serving as metal members, having heat conductivity lower than that of the cooling fin 6 are interposed between the fixing member 81 and the cooling fin 6. For example, in the case where the fixing member 81 and the cooling fin 6 are formed of aluminum, the cylindrical members 85 formed of stainless steel are arranged therebetween. In this case, the bolts 84 may also be formed of stainless steel, serving as a metallic material, having heat conductivity lower than that of the cooling fin 6. Thus, heat is prevented from being transferred from the cooling fin 6 to the fixing member 81 via the cylindrical members 85.

The modifications 1 to 3 mentioned above may be implemented singly or in combination of two or three of them. Thus, the heat received by the control circuit 8 from the cooling fin 6 is further reduced to further enhance the cooling performance of the control circuit 8

The present invention should not be construed as being limited to the foregoing embodiment but may be implemented in various modifications as far as the modifications are within the scope of the spirit of the present invention. The foregoing embodiment describes a motor-generator for vehicle that performs a motor operation and a generator operation. However, for example, the present invention may be applied to a rotary electric machine for vehicle that only performs the motor operation or the generator operation, or a rotary electric machine used for something other than a vehicle.

As shown in FIG. 2, the foregoing embodiment deals with a power converter including a single bridge circuit. However, the number of bridge circuits may be two or more. Also, the foregoing embodiment shows specific examples of forming the cooling fin 6 and the fixing member 81 with aluminum, and forming the bolts 84 with stainless steel. However, these components may be formed of other materials (e.g., copper or iron).

In the foregoing embodiment, the plurality of low-side switching elements and high-side switching elements, serving as power elements, are arranged on the first surface of the cooling fin 6 directly or via a circuit board. Alternatively, a set of low- and high-side switching elements corresponding to the same phase winding may be modularized and arranged on the cooling fin 6.

As described above, according to the above embodiment, the fixing member for fixing the control circuit to the frame is connected to the frame via the cooling fin. Accordingly, heat transfer from the frame to the control circuit is suppressed and thus the cooling performance for the control circuit is enhanced. Further, the control circuit is fixed to the frame via the fixing member and the cooling fin which are both made of metal. Accordingly, the amplification of the vibration transmitted from the frame to the control circuit during the operation of the rotary electric machine can be suppressed.

Hereinafter, aspects of the above-described embodiments will be summarized.

As an aspect of the embodiment, a rotary electric machine is provided which includes: a rotor (4); a stator (3); a power circuit (5) which includes a power element; a control circuit (8) which controls the power element; a frame (2) which accommodates the rotor (4) and the stator (3); a cooling fin (6) which is made of metal and is connected to the frame to cool the power circuit; and a fixing member (81) which is made of metal and is connected to the cooling fin to fix the control circuit.

The fixing member for fixing the control circuit to the frame is connected to the frame via the cooling fin. Accordingly, heat transfer from the frame to the control circuit is suppressed and thus the cooling performance for the control circuit is enhanced. Further, the control circuit is fixed to the frame via the fixing member and the cooling fin each made of metal. Accordingly, the amplification of the vibration transmitted from the frame to the control circuit during the operation of the rotary electric machine is suppressed.

What is claimed is:

1. A rotary electric machine, comprising:
a rotor;
a stator;
a power circuit which includes a power element;
a control circuit which controls the power element;
a frame which accommodates the rotor and the stator;
a cooling fin which is made of metal and is connected to the frame to cool the power circuit; and
a fixing member which is made of metal and is connected to the cooling fin to fix the control circuit.

2. The rotary electric machine according to claim 1, further comprising a cooling fan which is mounted to the rotor, wherein
the cooling fan rotates with the rotor and takes cooling air into the frame to cool the cooling fin.

3. The rotary electric machine according to claim 1, wherein
the fixing member is connected to the cooling fin by using a connecting member which is formed of a material having heat conductivity lower than that of the cooling fin.

4. The rotary electric machine according to claim 1, further comprising a metal member which has heat conductivity lower than that of the cooling fin and is interposed between the fixing member and the cooling fin.

5. The rotary electric machine according to claim 1, wherein
the fixing member is formed of a material having heat conductivity lower than that of the cooling fin.

6. The rotary electric machine according to claim 3, wherein
the cooling fin is formed of aluminum, and
the fixing member is a bolt formed of stainless steel.
